(19) United States
(12) Patent Application Publication
(10) Pub. No.: US 2006/0262905 A1
(43) Pub. Date: Nov. 23, 2006

(54) Reduced divergence electromagnetic field configuration

(76) Inventor: Leonard Reiffel, Chicago, IL (US)

Correspondence Address: William J Hallihan;Hallihan Intellectual Property Law, 125 South Wacker Drive, Suite 2080, Chicago, IL, 60606, US

(21) Appl. No.: 10/557,646

(22) PCT Filed: May 20, 2004
(86) PCT No.: PCT/US04/16028

§ 371 Date: Nov. 18, 2005

Related U.S. Application Data
(60) Provisional application No. 60/472,080, filed on May 20, 2003.

(51) Int. Cl. H05G 2/00; G21G 4/00; H01J 35/00

(52) U.S. Cl. 378/119

(57) ABSTRACT

A photon beam dose enhancement is controlled by configuring at least two magnets in a staggered opposing coil configuration, such that the first central field vector of the first magnet is more anti-parallel than parallel to the second central field vector of the second magnet. In one form, the first central field vector of the first magnet is rotated between ±90° to 180° to the second central field vector of the second magnet. Typically, the first central field vector is noncoaxial with the second central field vector. The resulting magnetic field configuration has a larger portion of higher magnitude magnetic field that can reach deeper into a target body and provides additional space within the region of higher magnitude that can accommodate larger portions of a body.

This application claims benefit of U.S. provisional application 60/472,080 filed 20 May 2003.

The electromagnetic field comprises at least a first magnetic field, which is opposed by at least a second magnetic field.

The first magnetic field has a first central field vector and the second magnetic field has a second central field vector. The first central field vector is more anti-parallel than parallel to the second central field vector. In one form, the first central field vector is staggered, or non-coaxial, with the second central field vector.

In one form, the first central field vector is displaced orthogonally from the second central field vector so that at least a portion of a combined field diverges less rapidly than the first magnetic field alone. The first central field vector can be displaced by two orthogonal components.

The first magnetic field can be produced by any means which can produce magnetic fields such as permanent magnets, current carrying coils, combinations of current carrying coils, and combinations of these.

The second magnetic field can be produced by any means which can produce magnetic fields such as permanent magnets, current carrying coils, combinations of current carrying coils, and combinations of these.

Magnetic field gradients can be used to enhance the cancer therapy capabilities of high-energy photon beams as taught in U.S. Pat. No. 5,974,112, which is incorporated herein by reference. For cancer therapy, as well as for other situations, it is very desirable to have more ready access to a region of comparatively high field and/or high field gradients than is typically available on the interior of a solenoid or in the gap between a so-called split aiding pair. (Such a split pair is comprised of two coaxial solenoids arranged along a common axis with a space between them and with the currents in both members of the pair circulating in the same direction.)

Here is disclosed a novel magnet pair configuration better-suited to projecting magnetic fields and gradients into objects too large to fit into the interior of a solenoid or into the gap in a split pair. The novel arrangement is termed a Staggered Opposing Coil Configuration (SOCC) and is shown in the accompanying figures.

In practicing the teachings of U.S. Pat. No. 5,974,122 using magnets in the SOCC configuration disclosed hering, for example, the tumor or target region in the patients body may be in the step in the magnet system as depicted in FIGS. 5-7 and 9-11.

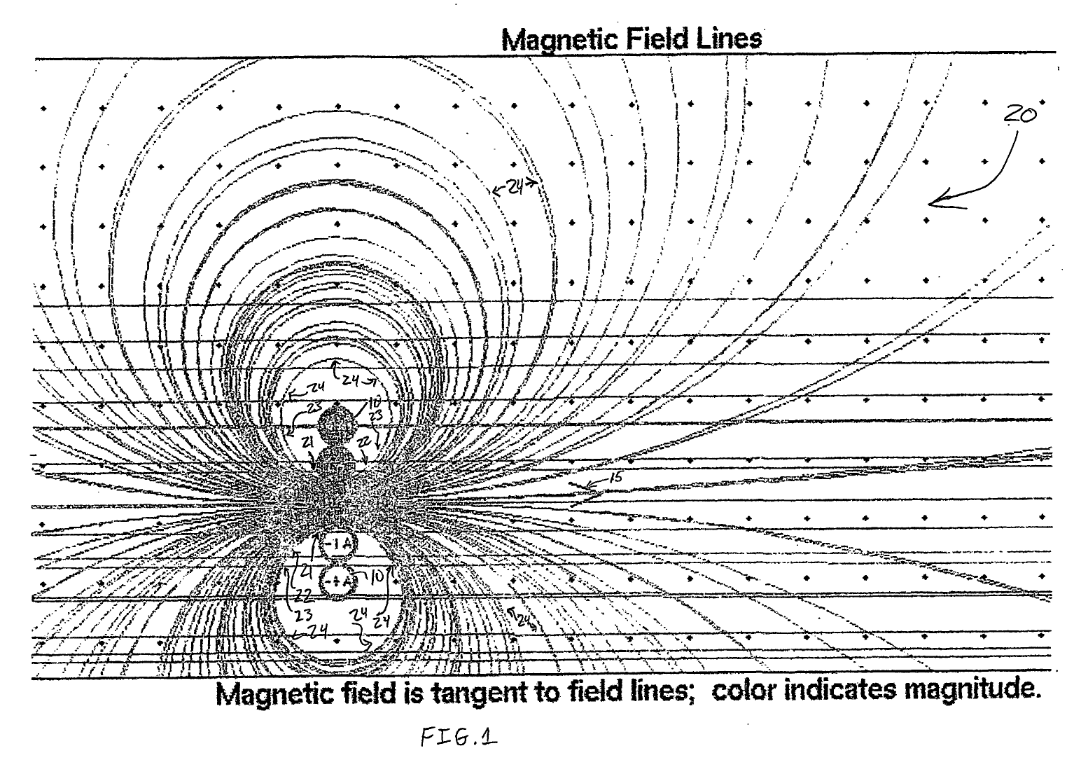

FIG. 1 is a section of a magnet with the field lines depicted.

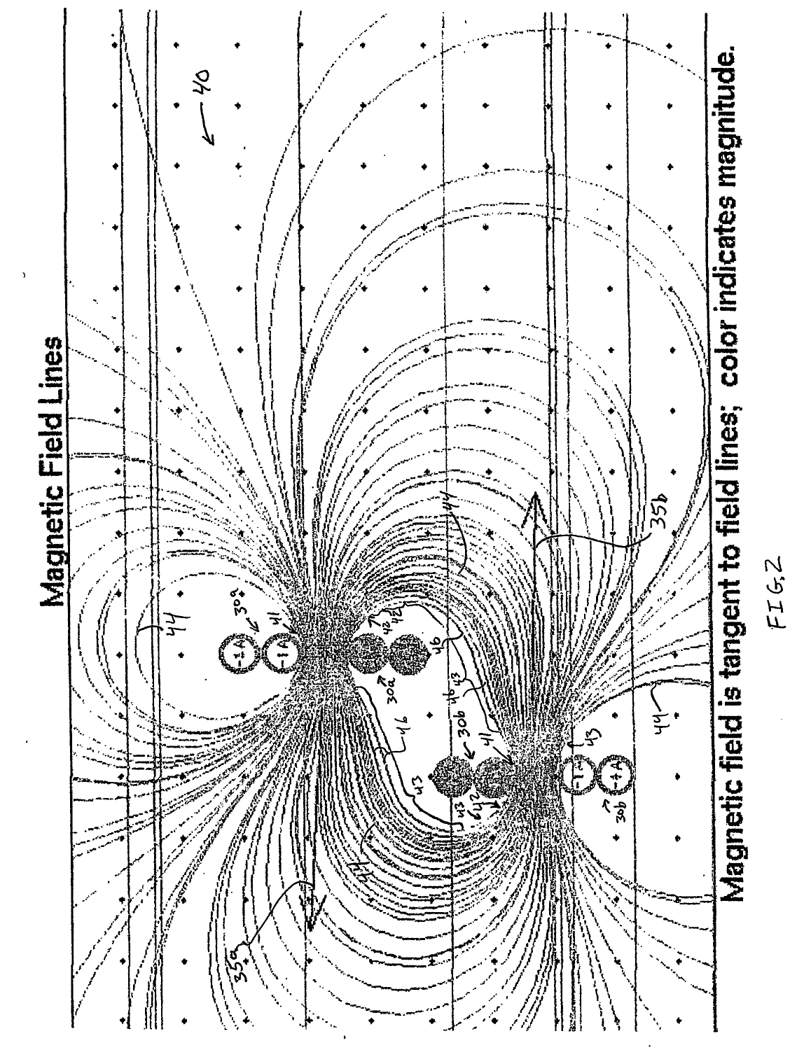

FIG. 2 is a section of two magnets in a Staggered Opposing Coil Configuration with field lines depicted, where the first central field vector of the first magnet is anti-parallel to the second central field vector of the second magnet.

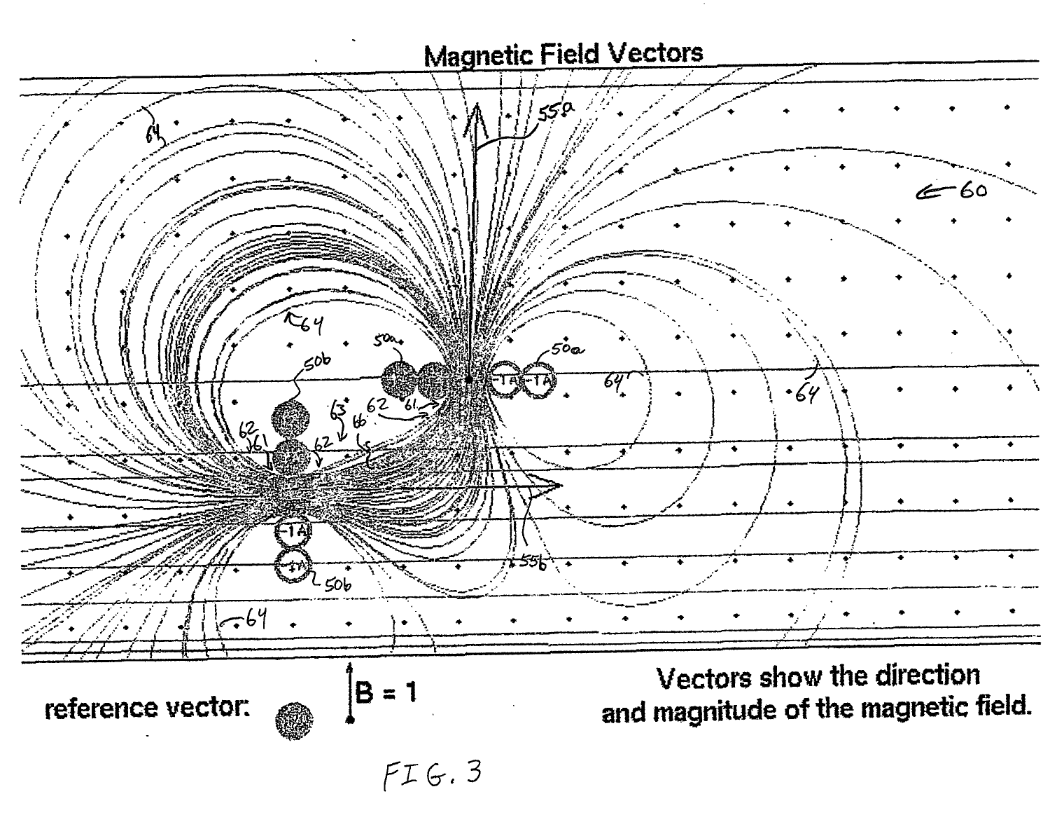

FIG. 3 is a section of two magnets in a Staggered Opposing Coil Configuration with field lines depicted, where the first central field vector of the first magnet is orthogonal to the second central field vector of the second magnet.

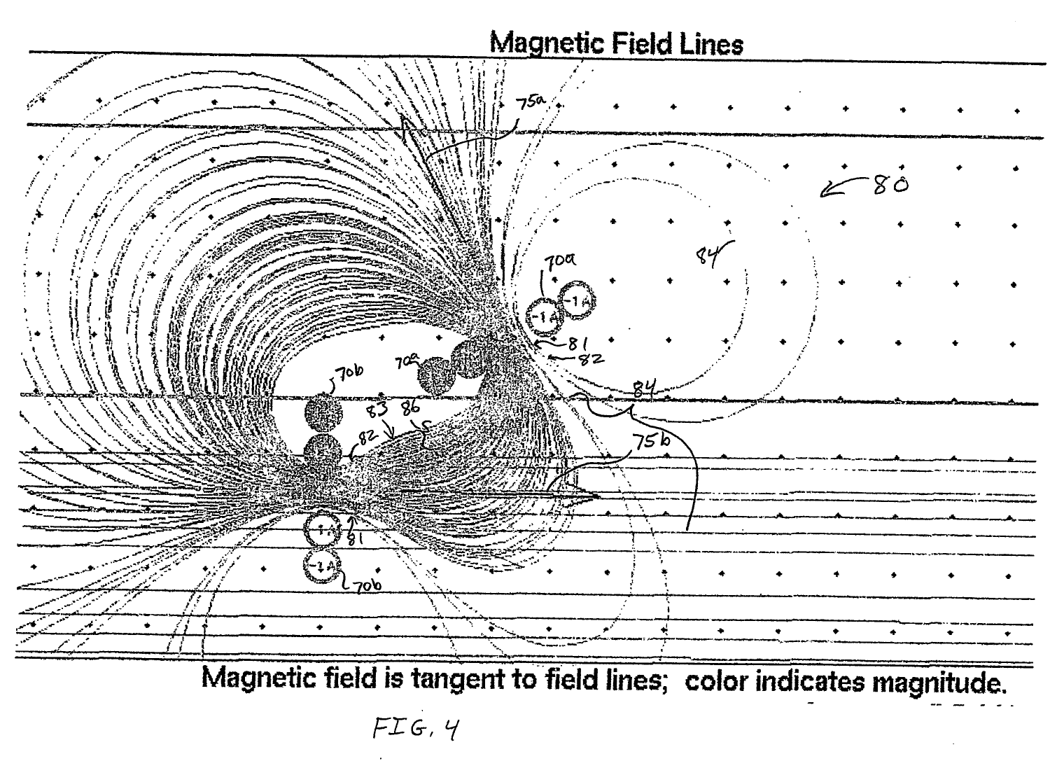

FIG. 4 is a section of two magnets in a Staggered Opposing Coil Configuration with field lines depicted, where the first central field vector of the first magnet is rotated between ±90° to 180° to the second central field vector of the second magnet.

FIG. 5 shows elements of a photon beam radiation system, with magnets (in cross-section) having anti-parallel central field vectors, to control dose enhancement.

FIG. 6 shows elements of a photon beam radiation system, with magnets (in cross-section) having orthogonal central field vectors, to control dose enhancement.

FIG. 7 shows elements of a photon beam radiation system, with magnets (in cross-section) having central field vectors with an axial offset between ±90° to 180° with respect to another central field vector, to control dose enhancement.

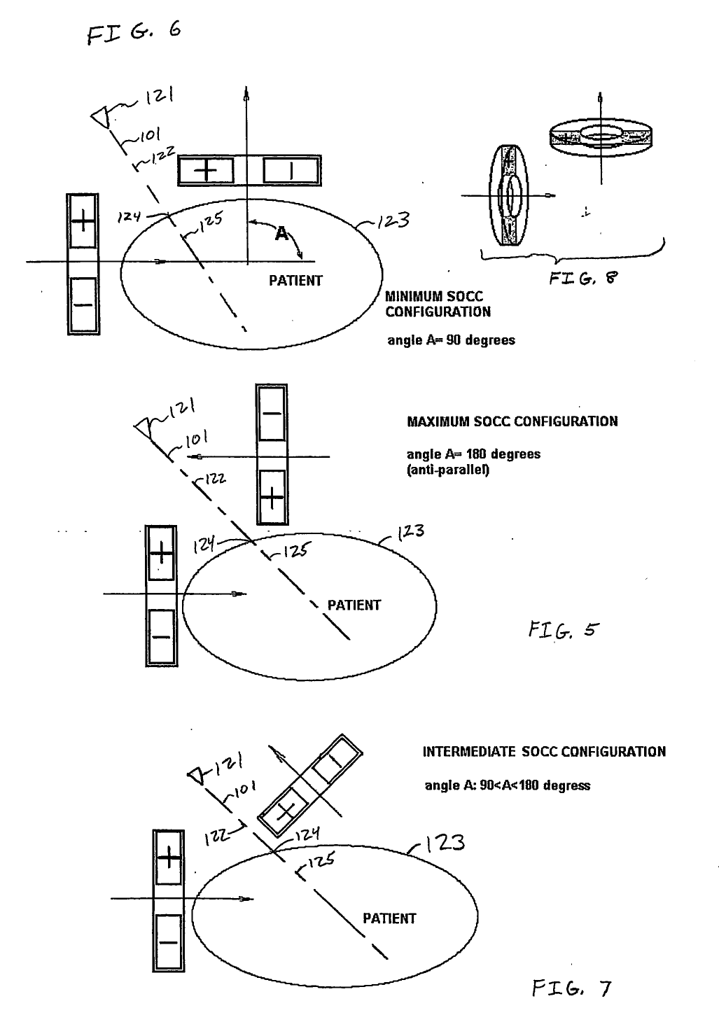

FIG. 8 is a perspective view of the magnets in the configuration of FIG. 6.

FIG. 9 shows elements of a photon beam radiation system, with magnets (in cross-section) in an anti-parallel configuration, to control dose enhancement to a torso target area

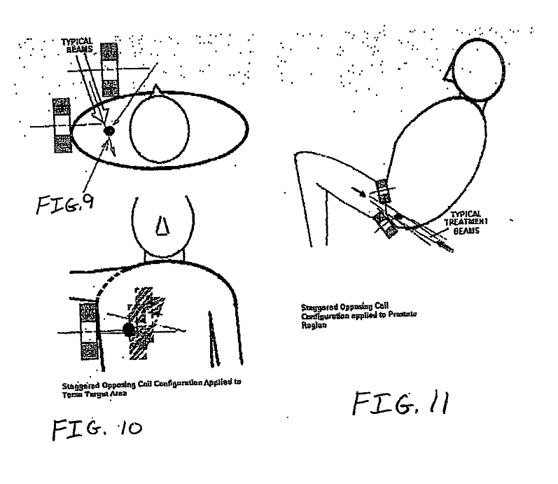

FIG. 10 shows elements of a photon beam radiation system, with magnets (offset between=90° to 180° with respect to one another) in an anti-parallel configuration, to control dose enhancement to a torso target area.

FIG. 11 shows elements of a photon beam radiation system, with magnets (offset between ±90° to 180° with respect to one another) in an anti-parallel configuration, to control dose enhancement to a prostrate target area

Referring to FIG. 1, a coil magnet 10 (shown in section) generates a magnetic field 20 having a central field vector 15. The color of the magnetic field lines indicates the magnitude of the field, such that areas of highest to lowest field and/or field gradients are red 21 (highest), followed by orange or yellow 22, green 23 and blue 24 (lowest).

Referring to FIG. 2, two coil magnets 30a, 30b (shown in section) are in a Staggered Opposing Coil Configuration, each magnet 30a, 30b contributing to an overall magnetic field 40. The first central field vector 35a of the first magnet 30a is rotated is anti-parallel to (rotated 180° from) the second central field vector 35b of the second magnet 30b. The color of the magnetic field lines indicates the magnitude of the field, such that areas of highest to lowest field and/or field gradients are red 41 (highest), followed by orange or yellow 42, green 43 and blue 44 (lowest). Comparing the magnetic fields between FIGS. 1 and 2 shows a larger portion of higher magnitude magnetic fields especially along the interior lines 46 between magnets 30a and 30b in FIG. 2.

Referring to FIG. 3, two coil magnets 50a, 50b (shown in section) are in a Staggered Opposing Coil Configuration, each magnet 50a, 50b contributing to an overall magnetic field 60. The first central field vector 55a of the first magnet 50a is rotated is orthogonal to (rotated 90° from) the second central field vector 55b of the second magnet 50b. The color of the magnetic field lines indicates the magnitude of the field, such that areas of highest to lowest field and/or field gradients are red 61 (highest), followed by orange or yellow 62, green 63 and blue 64 (lowest). Comparing the magnetic fields between FIGS. 1 and 3 shows a larger portion of higher magnitude magnetic fields especially along the interior lines 66 between magnets 50a and 50b in FIG. 3.

Referring to FIG. 4, two coil magnets 70a, 70b (shown in section) are in a Staggered Opposing Coil Configuration, each magnet 70a, 70b contributing to an overall magnetic field 80. The first central field vector 75a of the first magnet 70a is rotated between ±90° to 180° to the second central field vector 75b of the second magnet 70b. In this case, the first central field vector 75a is rotated approximately −135° (+225°) to the second central field vector 75b. The color of the magnetic field lines indicates the magnitude of the field, such that areas of highest to lowest field and/or field gradients are red 81 (highest), followed by orange or yellow 82, green 83 and blue 84 (lowest). Comparing the magnetic fields between FIGS. 1 and 4 shows a larger portion of higher magnitude magnetic fields especially along the interior lines 86 between magnets 70a and 70b in FIG. 4.

In FIGS. 1-4, it can be seen that the fields generated by the opposing current directions in the coils efficiently add together only in a localized region where the windings of the two coils most closely approach each other. This tends to project the desired field vectors further into the target region while not generating extremely large and difficult-to-control magnetic forces between the SOCC components. In other words, the magnetic field that results from using two magnets having central field vectors that are offset by ±90° to 180° from one another has a larger portion of a comparatively higher magnitude of strength of the magnetic field and/or higher gradient compared to the magnetic field from a single magnet. This results in a gain of 1, 2, 3 or more centimeters in depth for higher magnitudes of magnetic fields which can be especially useful for targeting tumors in a body with a photon beam source. It should be noted that the first central field vector is typically staggered, or non-coaxial, with the second central field vector.

Referring to FIGS. 5-7, there is shown a radiation system having a photon beam source 121 which produces an incident photon beam along a beam path, the beam path being defined by all of the paths of the incident photons in the beam. Though this beam path, can have a complicated cross section, a beam vector 101 can be chosen to represent the beam path. The photon beam is indicated by the point 122 on the beam vector 101. The beam vector 101 enters a body 123 at the point 124 and the incident photons generate an electron-photon cascade along the beam path, the electron-photon cascade being indicated by the point 125 on the beam vector 101 in the body 123.

At the energies of interest here the path of the electron-photon cascade, being the collection of the paths of the particles in the electron-photon cascade, can be considered to follow along the incident photon beam path. Thus, the electron-photon cascade can also be represented by the beam vector 101, so that beam path here means both the incident photon beam path and the beam path of the electron-photon cascade. The radiation system has a photon beam source which provides a photon beam incident on a body along a beam path. The photon beam generates an electron-photon cascade along the beam path in the body. A dose enhancement control device comprises a pair of magnets in a SOCC configuration. The SOCC magnet configuration results in a magnetic field configuration with a magnetic field component across the beam path and with a magnetic field gradient component along the beam axis which cause a relative dose profile, the relative dose profile being controlled by control of the magnetic field configuration. Further details concerning how the radiation system can be used, for example, the tumor or target region in the patients body may be in the step in the magnet system are shown in U.S. Pat. No. 5,974,122.

As suggested in FIGS. 9-11, SOCC magnet pairs can be made in any size and can be applied to many target regions including, but not limited to, those in the human torso, the pubic region, or the prostrate region. The members of a SOCC pair need not be of the same size. The magnet axes may be skewed with respect to each other and need not lie in the same plane nor be in the same plane as, for example, a photon beam that might be used for cancer therapy. The photon beam may target the cancer at a variety of angles and directions and need not be used from any particular reference point with respect to the SOCC pair. The magnets of a SOCC can be moved with respect to each other during use or adjusted between uses to affect the position and shape of the fields generated. Such changes can be controlled and coordinated with changes of photon beam characteristics such as when IMRT (Intensity Modulated Radiation Therapy) procedures are used in the treatment of cancer. While simple coils are shown, a given coil can be an array of coils. While magnet coils are typically wound as circular solenoids, other cross-sectional shapes such as racetracks and ovals may be usefully employed.

The SOCC arrangement can be employed using permanent magnets as one or more of the field sources.

The teaching herein can be applied to manipulating electron beams or beams of other types of charged particles.

In use, the radiation system uses a dose enhancement method that can include choosing a relative dose profile and configuring at least two magnets in a SOCC configuration so that the resulting magnetic field configuration has a magnetic field component across the beam path with a magnetic field gradient component along the beam path which cause the relative dose profile, the relative dose profile being controlled by control of the magnetic field configuration. The magnetic field configuration can be controlled by, among other things, adjusting the relative placement of the magnets with respect to one another. The magnetic field configuration can also be controlled by moving at least one of the magnets in the SOCC configuration.

As shown in FIGS. 5-7 and 9-11, a first magnet can be placed adjacent one portion of a body and a second magnet can be placed against second portion of the body such that the magnets are in a SOCC configuration. In one form, a first magnet is placed in the area of the groin while the second magnet is placed in the area of the buttocks in order to treat a tumor in the prostrate area or in the groin region. In another form, the first magnet is placed adjacent one portion of the torso while the second magnet is placed adjacent another portion of the torso to treat a tumor within the torso, such as in the lungs. In another form, the first magnet is placed adjacent one portion of the head while the second magnet is placed adjacent another portion of the head to treat a tumor within the head, such as in the brain. In another form, the first magnet is placed adjacent one portion of the neck while the second magnet is placed adjacent another portion of the neck to treat a tumor within the neck, such as in the lymph nodes.

What is claimed is:

1. A radiation system, comprising a photon beam source which provides a photon beam incident on a body along a beam path, the photon beam generating an electron-photon cascade along the beam path in the body, a dose enhancement control device comprising at least two magnets, a first magnet has a first central field vector and a second magnet has a second central field vector with the first central field vector and the second central field vector being offset between ±90° to 180° with respect to one another.

2. The device of claim 1, wherein the at least two magnets have a combined magnetic field configuration with a magnetic field component across the beam path and with a magnetic field gradient component along the beam axis which cause a relative dose profile, the relative dose profile being controlled by control of the magnetic field configuration.

3. The device of claim 1 wherein the first central field vector and the second central field vector are non-coaxial.

4. The device of claim 1 wherein the first magnet is placed adjacent one portion of the body and the second magnet is placed adjacent another portion of the body.

5. The device of claim 1 wherein the first central field vector is orthogonal to the second central field vector.

6. The method of claim 5 wherein the magnetic field configuration is controlled by moving at least one of the at least two magnets.

7. The method of claim 6 wherein the magnetic field configuration is controlled by adjusting the relative placement of at the first magnet with respect to the second magnet.

8. In a radiation system, the radiation system having a photon beam source which provides a photon beam incident on a body along a beam path, the photon beam generating an electron-photon cascade along the beam path in the body, a dose enhancement control device comprising at least two magnets, a first magnet has a first central field vector and a second magnet has a second central field vector, the first central field vector and the second central field vector are non-coaxial.

9. The device of claim 8 wherein the first central field vector is more anti-parallel than parallel to the second central field vector.

10. The device of claim 8 wherein the first magnet is placed adjacent one portion of the body and the second magnet is placed adjacent another portion of the body.

11. The device of claim 9 wherein the first central field vector is anti-parallel to the second central field vector.

12. A dose enhancement method used in a radiation system, the radiation system having a photon beam source which provides a photon beam incident on a body along a beam path, the photon beam generating an electron-photon cascade along the beam path in the body, the dose enhancement method comprising the steps:
choosing a relative dose profile;
configuring at least two magnets, a first magnet having a first central field vector and a second magnet having a second central field vector, the first central field vector and the second central field vector are non-coaxial; and
wherein the resulting magnetic field has a magnetic field component across the beam path and with a magnetic field gradient component along the beam path which cause the relative dose profile, the relative dose profile being controlled by control of the magnetic field configuration.

13. The method of claim 12 wherein the magnetic field configuration is controlled by moving at least one of the at least two magnets.

14. The method of claim 12 wherein the magnetic field configuration is controlled by adjusting the relative placement of the magnets with respect to one another.

15. The method of claim 12 further comprising placing the first magnet adjacent one portion of the body and placing the second magnet adjacent another portion of the body.

16. The method of claim 12 wherein the first central field vector is more anti-parallel than parallel to the second central field vector.

17. The method of claim 12 wherein the first central field vector and the second central field vector being offset between ±90° to 180° with respect to one another.

18. The method of claim 17 wherein the first central field vector is orthogonal to the second central field vector.

19. The method of claim 17 wherein the first central field vector and the second central field vector being offset between ±100° to 170° with respect to one another.

20. The method of claim 19 wherein the first central field vector and the second central field vector being offset between ±110° to 160° with respect to one another.

21. The method of claim 20 wherein the first central field vector and the second central field vector being offset between ±120° to 150° with respect to one another.

22. The method of claim 21 wherein the first central field vector and the second central field vector being offset between ±130° to 140° with respect to one another.
